(19) United States
(12) Patent Application Publication
(10) Pub. No.: US 2024/0125369 A1
(43) Pub. Date: Apr. 18, 2024

(54) SPRING ELEMENT

(71) Applicant: VALEO INDIA PRIVATE LIMITED, Chennai (IN)

(72) Inventors: Dinesh Kumar MURUGAN, Chennai (IN); Bala Anand RAMESH, Chennai (IN); Pradeepkumar MANI, Chennai (IN); Rajkumar MAGALINGAM, Chennai (IN); Becem NAJJAR, La Verriere (FR); Remi TOURNOIS, La Verriere (FR)

(73) Assignee: VALEO INDIA PRIVATE LIMITED, Chennai (IN)

(21) Appl. No.: 18/264,028

(22) PCT Filed: Feb. 7, 2022
(86) PCT No.: PCT/IN2022/050102

§ 371 Date: Aug. 2, 2023

(30) Foreign Application Priority Data
Feb. 12, 2021 (IN) 202141006064

(51) Int. Cl. F16F 1/18; F16F 3/02; F16F 13/02

(52) U.S. Cl. CPC F16F 1/187; F16F 3/023; F16F 13/02; F16F 2234/06

(57) ABSTRACT

A spring element includes a body, at least one leaf spring and a stress relieving section. The body includes at least one mounting section. The leaf spring includes a first portion and a second portion. The first portion being secured to the body and at least a part thereof extends angularly with respect to a plane of the body. The leaf spring exerts an urging pressure on an element disposed between the body and a housing as the body is mounted on the housing. The stress relieving section is formed along at least one lateral side of the leaf spring and proximal to the first portion.

### TECHNICAL FIELD

The present invention relates to a spring element or a biasing element, more particularly, the present invention relates to a biasing element to hold together elements of a power transistor, such as for example, an Insulated Gate Bipolar Transistor (IGBT) assembly.

### BACKGROUND OF THE INVENTION

The power transistor assembly, such as for example, a Metal Oxide Silicon Field Effect Transistor (MOSFET) or an Insulated Gate Bipolar Transistor, hereinafter referred to as an IGBT is a switching device. Particularly, the IGBT is a three-terminal semiconductor switching device that is used for fast switching with high efficiency in many types of electronic devices mostly used in amplifiers for switching/processing complex wave patters with pulse width modulation (PWM). The IGBT assembly is mounted on a base, for example, a housing of vehicle mounted component, for example, a vehicle mounted electric heater and generally includes a IGBT holder, a thermal pad, the IGBT and an IGBT spring element that are sequentially arranged in this order with respect to each other, wherein the thermal pad is disposed between the housing and the IGBT. Generally, the housing is of plastic material and the IGBT is of semiconductor material. The IGBT receives thermal signal from the housing to perform the switching function, for example, switching off operation of the electric heater, incase temperature exceeds a predetermined temperature limit. The contact between the IGBT and the housing is critical for efficient performance of the IGBT. The IGBT spring element is mounted on the housing by using threaded bolts. The IGBT spring element urges the intermediate elements, particularly, the IGBT, the thermal pad and the IGBT holder held between the IGBT spring element and the housing against the housing, to ensure proper and sufficient contact between the IGBT and the housing as the IGBT assembly is mounted on the housing. Also, heat is generated during the operation of the IGBT and the heat generated during operation of the IGBT is required to be dissipated. The thermal pad disposed between the IGBT and the housing dissipates the heat generated by the IGBT during operation thereof and maintains temperature of the IGBT within permissible limit. The thermal pad disposed between the IGBT and the housing also enhances the contact between the IGBT and the housing to improve thermal input signal received from the housing to the IGBT for efficient performance of the IGBT.

Referring to FIG. 1 of the accompanying drawings, the conventional IGBT spring element 1 includes a body 2 with openings 2a and 2b formed thereon. The conventional IGBT spring element 1 further includes at least two leaf springs 6a and 6b, such that the openings 2a and 2b circumscribe at least a portion of the periphery of the respective leaf springs 6a and 6b.

Generally, the body 2 includes at least one mounting section 3a, 3b and at least one connecting section 4. Specifically, the body 2 of the conventional IGBT spring element 1 includes two mounting sections 3a and 3b connected by one connecting section 4 as illustrated in FIG. 1. The mounting sections 3a and 3b are to mount the body 2 on a base, for example, on a housing of a vehicle mounted component, such as the electric heater. More specifically, bolts are used to mount the body 2 on the housing of the electric heater. Each of the mounting sections 3a and 3b include hole formed thereon, the bolt passes through the hole on the mounting section and engages with the corresponding aperture on the housing to mount the body 2 on the housing. More specifically, the bolts are threaded bolts that threadably engage with complimentary internal threads formed on the hole on the mounting section and the aperture on the housing as the bolts are tightened. The connecting section 4 is disposed between and connecting the pair of mounting sections 3a and 3b. The pair of openings 2a and 2b are formed on the connecting section 4.

The leaf spring 6a, 6b of the conventional IGBT spring element 1 is of uniform width, wherein the width of the leaf spring 6a, 6b being determined along a direction orthogonal to the longitudinal axis of the leaf spring 6a, 6b. The leaf spring 6a, 6b includes a first portion 7a, 7b proximal to a fixed end thereof and a second portion 8a, 8b proximal to the free end thereof. The second portion 8a, 8b of the leaf spring 6a, 6b is shorter than the first portion 7a, 7b. The first portion 7a, 7b is secured to the body 2 and at least a part 9a, 9b of the first portion 7a, 7b protrudes along a curved profile from the body 2. The part 9a, 9b of the first portion 7a, 7b is disposed at the interface between the first portion 7a, 7b and the second portion 8a, 8b. At least a portion of the leaf spring 6a, 6b exerts a predetermined pressure on the IGBT disposed between the IGBT spring element 1 and the housing, as the body 2 is mounted on the housing by tightening the bolts. However, the leaf spring for urging the IGBT towards the housing to hold the critical elements of the IGBT assembly together by applying a predetermined pressure for ensuring proper and sufficient contact between the housing and the IGBT is subjected to stresses due to abrupt change in cross sections and high displacements transmitted to critical sections thereof. Accordingly, the IGBT spring is prone to mechanical failures and the IGBT assembly requires regular maintenance or replacement. In case, even one of the leaf spring fails, the entire IGBT spring is required to be replaced, thereby increasing the maintenance costs.

Accordingly, there is a need for an improved IGBT spring element that prevents stress concentration and high displacement at critical sections thereof, thereby reducing chances of mechanical failure and enhancing reliability and service life of the IGBT spring element.

An object of the present invention is to provide an IGBT spring element that prevents stress concentration and high displacement at critical sections of the IGBT spring and accordingly obviates the drawbacks associated with conventional IGBT spring.

Another object of the present invention is to provide an IGBT spring element that is comparatively less prone to mechanical failure compared to conventional IGBT spring element, thereby enhancing reliability and service life of the IGBT spring element.

Yet another object of the present invention is to provide an IGBT spring element that is simple in construction and convenient to use.

In the present description, some elements or parameters can be indexed, such as a first element and a second element. In this case, unless stated otherwise, this indexation is only meant to differentiate and name elements which are similar but not identical. No idea of priority should be inferred from such indexation, as these terms can be switched without betraying the invention. Additionally, this indexation does not imply any order in mounting or use of the elements of the invention.

### SUMMARY OF THE INVENTION

A spring element is disclosed in accordance with an embodiment of the present invention. The spring element includes a body, at least one leaf spring and a stress relieving section formed on the leaf spring. The body includes at least one mounting section to mount the body on a housing. The at least one leaf spring includes a first portion and a second portion. The first portion being secured to the body and at least a part thereof extends angularly with respect to a plane of the body. The leaf spring exerts a predetermined urging pressure on an element disposed between the body and the housing as the body is mounted on the housing. The leaf spring further includes a stress relieving section formed along at least one lateral side of the leaf spring and proximal to the first portion.

Generally, the body includes at least one connecting section disposed between and connecting a pair of mounting sections to define the plane of the body.

Specifically, the pair of mounting sections are coplanar with respect to each other and offset from the plane of the body.

Particularly, the mounting section includes a mounting hole formed thereon to receive a mounting bolt that engages with an aperture formed on the housing to mount the body on the housing.

Preferably, the mounting hole, particularly, center of the mounting hole is aligned to a longitudinal axis “L” of the leaf spring and is proximal to the first portion of the leaf spring.

Specifically, the connecting section includes a pair of spaced apart openings configured thereon and forming a central bridge portion between the openings, each opening circumscribing at least a portion of a periphery of the leaf spring.

More specifically, the spaced apart openings are coplanar with respect to each other.

Particularly, the leaf spring is of varying width along length thereof, the width of the leaf spring being determined along a direction orthogonal to the longitudinal axis “L” of the leaf spring.

Generally, the leaf spring is comparatively smaller than the respective opening.

Particularly, at least a portion of the leaf spring protrudes from the plane of the body and

in a direction opposite to the mounting section of the body.

Preferably, the second portion is comparatively shorter than the first portion of the leaf spring.

Specifically, a connecting part of the first portion of the leaf spring secured to the body protrudes from the plane of the body and the remaining part of the first portion angularly extends from the plane of the body along a straight line.

In accordance with an embodiment of the present invention, the part of the first portion further includes ribs formed thereon.

Generally, the stress relieving section is in the form of cutout.

Preferably, the cutout is a C-shaped cutout formed on both lateral sides of the leaf spring and proximal to the first portion of at least one the leaf spring.

Preferably, the radius of the C-shaped cutout is in the range of 1 to 5 mm.

Further is disclosed an electrical heater in accordance with an embodiment of the present invention. The electrical heater includes at least one power transistor urged against a housing of the electrical heater by the spring element as disclosed above.

### BRIEF DESCRIPTION OF DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates a schematic representation of a conventional spring element;

FIG. 2a illustrates a spring element in accordance with an embodiment of the present invention mounted on a housing of a vehicle mounted electric heater;

FIG. 2b illustrates a schematic representation of the spring of the FIG. 2a;

FIG. 3 illustrates a top view of the spring element of FIG. 2b;

FIG. 4 illustrates another isometric view of the spring element of FIG. 2b;

FIG. 5 illustrates a side sectional view of the spring element of FIG. 3 along the longitudinal axis of the leaf spring;

FIG. 6a illustrates an isometric view of the spring element in accordance with another embodiment of the present invention;

FIG. 6b illustrates a side view of the spring element of FIG. 6a.

FIG. 7a illustrates spring element in accordance with one embodiment, where spring element is formed with different shaped cutout at the interface between the body and the leaf spring;

FIG. 7b illustrates spring element in accordance with another embodiment, where spring element is formed with different shaped cutout at the interface between the body and the leaf spring;

FIG. 7c illustrates spring elements in accordance with different embodiments, where spring element is formed with different shaped cutout at the interface between the body and the leaf spring;

FIG. 7d illustrates spring element in accordance with yet another embodiment, wherein the cutouts are provided on the leaf spring and portion of the body opposite to the cutouts formed on the leaf spring; and

FIG. 7e illustrates spring element in accordance with yet another embodiment, wherein the cutouts are provided on the leaf spring and portion of the body opposite to the cutouts formed on the leaf spring.

### DETAILED DESCRIPTION OF THE INVENTION

It must be noted that the figures disclose the invention in a detailed enough way to be implemented, said figures helping to better define the invention if needs be. The invention should however not be limited to the embodiment disclosed in the description.

The present invention envisages a spring element, particularly an IGBT spring element to urge elements of an IGBT assembly, particularly, an IGBT, a thermal pad, and an IGBT holder arranged in that order against a base, particularly, a housing of an electric heater, when the IGBT assembly is mounted on the housing. The base can be any one of cover, bracket or any other structural element. As the IGBT is urged against the housing with the thermal pad in between, the IGBT receives thermal signal from the housing. The IGBT is required to be in sufficient contact with the housing. By urging the IGBT against the housing, proper and sufficient contact between the IGBT and the housing to improve the performance of the IGBT is achieved. Particularly, the IGBT spring element includes a leaf spring that exerts the urging force on the other elements of the IGBT assembly. Generally, the IGBT spring, in particular leaf spring, inherently remains in stress as the IGBT spring element urges the remaining elements of the IGBT assembly disposed between the IGBT spring and the housing against the housing. However, the IGBT spring element of the present invention prevents stress concentration and large displacements at critical sections thereof, thereby reducing the chances of mechanical failure and improving reliability and service life of the IGBT spring element. More particularly, the IGBT spring element of the present invention includes strategically disposed stress relieving sections in the form of cutouts to prevent stress concentrations at the critical sections of the IGBT spring element arising due to abrupt change in cross sections. The IGBT spring element of the present invention further includes strategically disposed straight sections to prevent high displacement at critical sections of the IGBT spring due to displacement traversing to the critical sections.

In the forthcoming description and accompanying drawings, the present invention is explained with example of IGBT spring assembly, wherein the IGBT spring element urges the elements of the IGBT assembly disposed between the IGBT spring and the housing against the housing. Although the present invention is explained with example of spring for IGBT spring assembly, the same is applicable for other power transistor such as the Metal Oxide Silicon Field Effect Transistor (MOSFET). However, the present invention is also applicable to any spring element used in vehicular and non-vehicular environment. Particularly, the present invention is applicable to any spring that urges at least one element against another and is configured with stress relieving features required to reduce stress concentration and displacements at critical sections of the spring to improve reliability and service life thereof to obviate the drawbacks associated with the spring constantly being subjected to stresses.

An IGBT assembly is mounted on the housing of the electric heater. Particularly, the IGBT assembly urges an IGBT against the housing to configure contact between the IGBT and the housing for receiving thermal signal from the housing and efficient performance of the IGBT. The IGBT assembly includes an IGBT holder, a thermal pad, the IGBT and an IGBT spring element that are sequentially arranged in this order with respect to each other and relative to the housing.

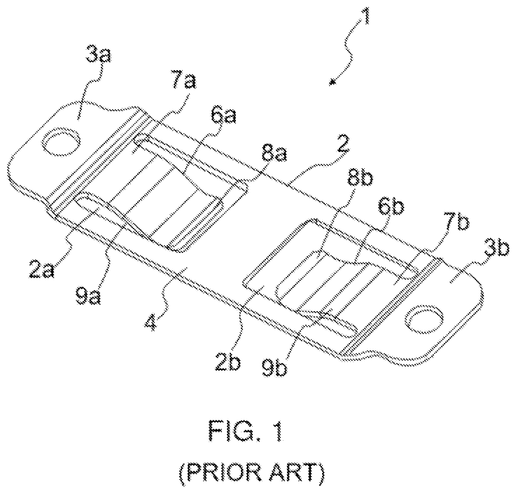

FIG. 1 illustrates a schematic representation of a conventional spring element 1. The conventional spring element 1 includes a body 2 and a pair of leaf spring 6a and 6b. The body 2 is of laminar configuration defining a plane of the body 2. The body 2 of the conventional spring 1 further includes a pair of mounting sections 3a and 3b for mounting the body 2 on a housing. The leaf spring 6a, 6b includes a first portion 7a, 7b and a second portion 8a, 8b. The first portion 7a, 7b is secured to the body 2 and at least a part 9a, 9b of the first portion 7a, 7b protrudes from the plane of the body 2 in a direction orthogonal to the plane of the body 2 and opposite to the mounting section 3a, 3b. In case of the conventional spring element 1, there is abrupt change in cross section at certain critical sections, particularly, at connecting part of the first portion 7a, 7b proximal to the fixed end of the corresponding leaf spring 6a, 6b. Such abrupt change in the cross section cause stress concentrations at the critical sections, thereby leading to mechanical failure and reducing service life and reliability of the conventional spring element 1.

The present invention envisages a spring element based on design modifications with respect to the conventional spring element to obviate the problems faced by conventional spring elements. More specifically, the spring element of the present invention includes strategically disposed stress relieving sections in the form of cutouts to prevent stress concentrations at the critical sections of the spring element arising due to abrupt change in cross sections thereof. The spring element of the present invention further includes strategically disposed straight sections that extends from the plane of the body along a straight line and in a direction perpendicular to the plane of the body of the spring element to prevent high displacement at critical sections of the spring element due to displacement traversing to the critical sections thereof.

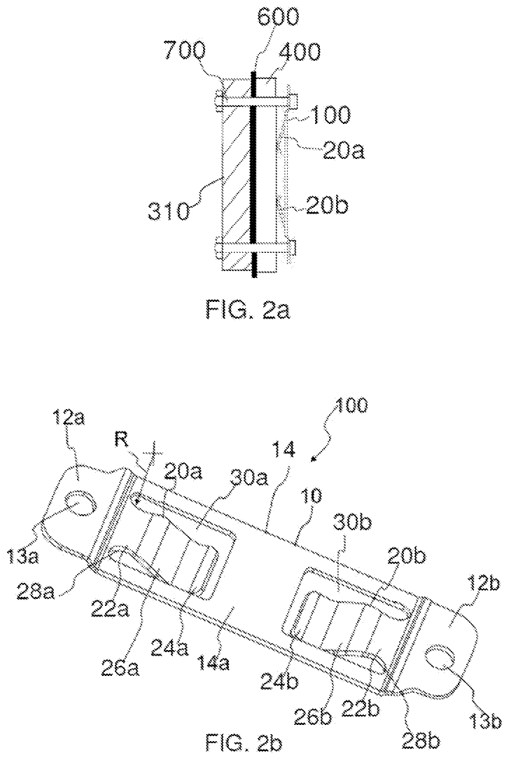

FIG. 2a illustrates a schematic representation of a spring element 100 in accordance with an embodiment of the present invention mounted on a base, for example, a housing 310 of a vehicle mounted component, such as a vehicle mounted electric heater 300 with an IGBT holder 500, a thermal pad 600 and an IGBT 400 sequentially arranged in this order with respect to each other and the housing 310. More specifically, the IGBT holder 500, the thermal pad 600 and the IGBT 400 are held between the spring element 100 and the housing 310, wherein the IGBT 400 is adjacent to the spring element 100 and the thermal pad 600 is disposed between the IGBT 400 and the housing 310. The base can be any one of cover, bracket or any other structural element. The spring element 100 is mounted on the housing 310 of the electric heater 300 through bolts 700. Specifically, the spring element 100 exerts pressure on the IGBT holder 500, the thermal pad 600 and the IGBT 400 that are sequentially arranged in this order with respect to each other and the housing 310. More specifically, the spring element 100 exerts urging pressure on the IGBT 400 to urge the IGBT 400 against the housing 310, when the body 10 is mounted on the housing 310 by tightening the bolts 700. The thermal pad 600 disposed between the IGBT 400 and the housing 310 also enhances the contact between the IGBT 400 and the housing 310 to improve thermal input signal received from the housing 310 to the IGBT 400 for efficient performance of the IGBT 400.

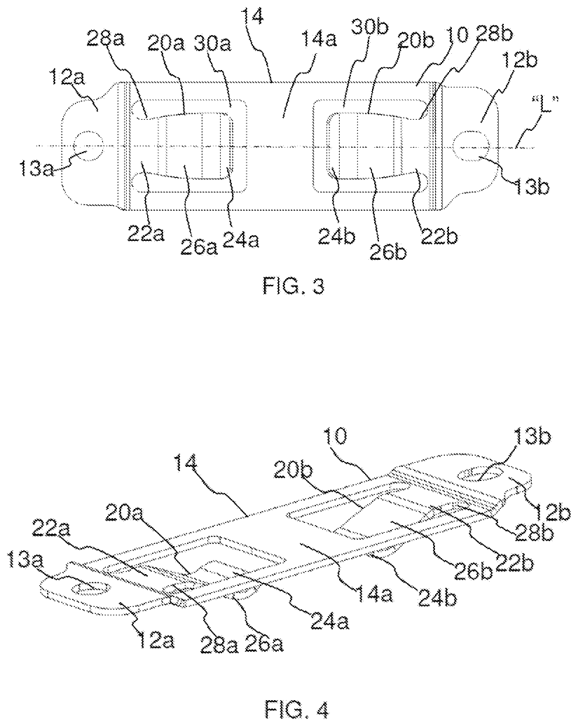

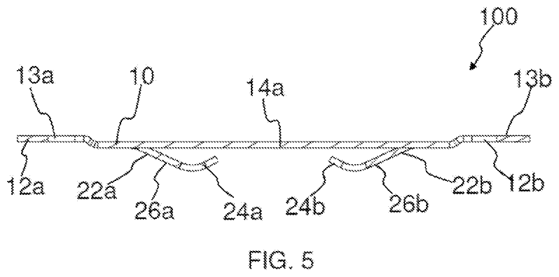

FIG. 2 illustrates a schematic representation of the spring element 100. FIG. 3 illustrates a top view of the spring element 100. FIG. 4 illustrates another isometric view of the spring element 100. The spring element 100 includes a body 10, at least one leaf spring 20a, 20b and a stress relieving section 28a, 28b formed on the corresponding leaf spring 20a, 20b. FIG. 5 illustrates a side sectional view of the spring element 100 along a longitudinal axis “L” of the leaf spring 20a, 20b.

The body 10 includes at least one mounting section 12a and 12b to mount the body 10 on the housing 310 of the electric heater. Referring to the FIG. 2b, the body includes at least one pair of mounting sections 12a and 12b. The body 10 of the spring element 100 further includes at least one connecting section 14 disposed between and connecting the pair of mounting sections 12a and 12b to define the plane of the body 10. The pair of mounting sections 12a and 12b are coplanar with respect to each other and offset from the connecting section 14. With the body 10 of the spring element 100 being mounted on the housing 310 at two separate mounting points, the degree of freedom of the body is limited, e.g. angular movement of the body 10 with respect to the housing 310 is arrested. Although the spring element 100 depicted in the accompanying drawings includes two mounting sections 12a and 12b, the body 10 of the spring element 100 can be configured with more than two mounting sections 12a and 12b. The mounting sections 12a and 12b includes respective mounting holes 13a and 13b formed thereon to receive mounting bolts. More specifically, mounting bolts are threaded bolts that pass through holes 13a and 13b formed on the mounting section 12a and 12b and engage with complimentary apertures formed on the housing 310 to mount the body 10 of the spring element 100 over the housing 310.

The spring element 100 generally includes a pair of leaf springs 20a and 20b. Generally, the leaf spring 20a, 20b extends from the fixed end thereof to the free end. The leaf spring 20a, 20b has a certain thickness. The width of the leaf spring 20a, 20b is determined along a direction orthogonal to the longitudinal axis “L” of the leaf spring 20a, 20b. The thickness of the leaf spring is determined in a direction orthogonal to the longitudinal axis “L” of the leaf spring 20a, 20b and also orthogonal to the width of the leaf spring 20a, 20b.

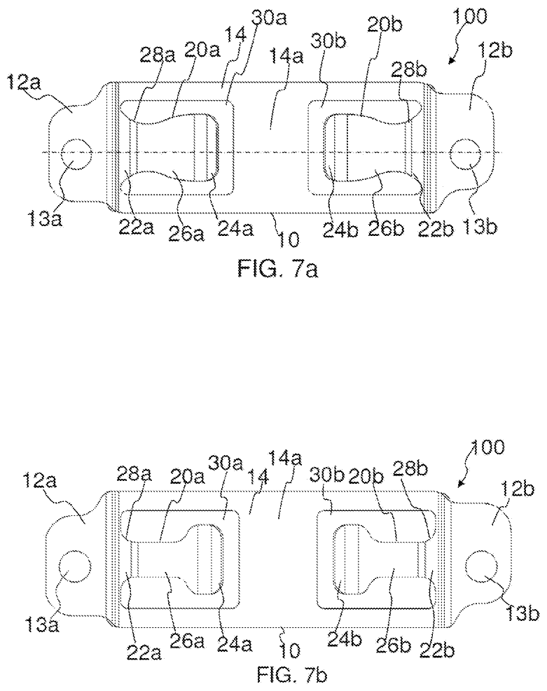

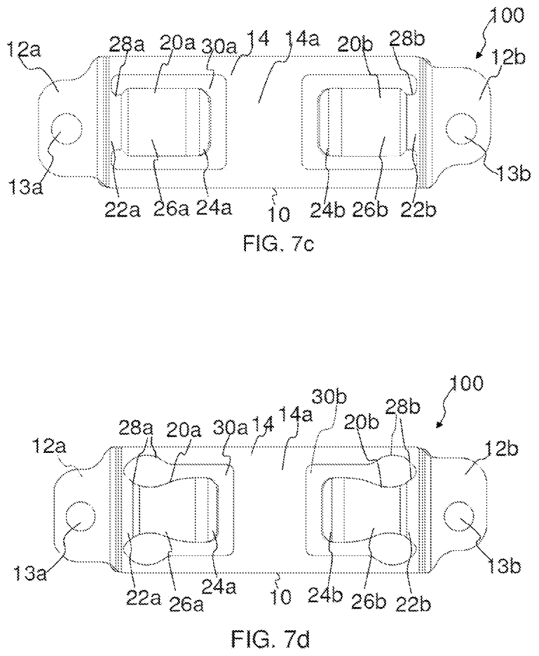

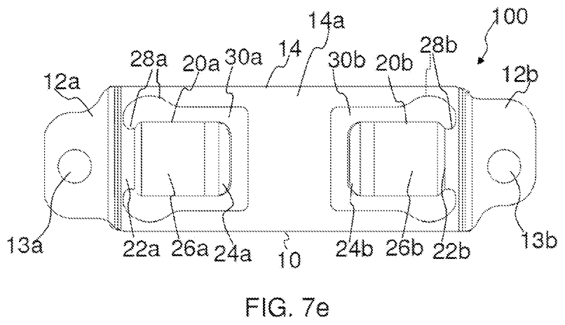

Specifically, the leaf spring 20a, 20b includes a first portion 22a, 22b and a second portion 24a, 24b. The second portion 24a, 24b of the leaf spring 20a, 20b is comparatively shorter than the first portion 22a, 22b. The first portion 22a, 22b being secured to the body 10 and at least a part 26a, 26b thereof extends angularly with respect to a plane of the body 10 in a direction orthogonal to the plane of the body. The leaf spring 20a, 20b exerts a predetermined urging pressure on an element disposed between the body 10 and the housing 310 as the body 10 is mounted on the housing 310. More specifically, the spring element 100 urges the IGBT against the housing 310 as the body 10 of the spring element 100 is mounted on the housing 310. The mounting hole 13a, 13b formed on the mounting section 12a,12b is aligned to a longitudinal axis “L” of the leaf spring 20a, 20b. Particularly, the center of the mounting hole 13a, 13b is aligned to a longitudinal axis “L” of the leaf spring 20a, 20b and is proximal to the first portion 22a, 22b of the leaf spring 20a, 20b. The leaf spring 20a, 20b is of varying width along length thereof, the width of the leaf spring 20a, 20b being determined along a direction orthogonal to the longitudinal axis “L” of the leaf spring 20a, 20b. In case, the spring element includes two leaf springs 20a and 20b, each leaf spring 20a, 20b exerts a predetermined pressure in the range of 250 to 300 Kpa on the element disposed between the body 10 and the housing 310 as the body 10 is mounted on the housing 310. As the leaf springs 20a and 20b exert urging forces on the intermediate element, particularly, the IGBT, disposed between the body 10 of the spring element 100 and the housing 310, the spring element 100, particularly, the leaf springs 20a and 20b of the spring element 100 is subjected to stress concentration and is prone to mechanical failures. The spring element 100 of the present invention includes strategically disposed stress relieving sections 28a, 28b in the form of cutouts formed at the critical sections of the spring element 100 to prevent stress concentrations thereat arising due to abrupt change in cross section. Specifically, the cutouts prevent abrupt change in cross cross-section at critical areas, particularly, at the interface between the leaf spring 20a, 20b and the body 10 to prevent stress concentration thereat. More specifically, the cutout at the interface between the leaf spring 20a, 20b and the body 10 is forming a gradual changing cross section at the interface. Generally, the cut outs are provided on the leaf spring 20a, 20b at the interface between the leaf spring 20a, 20b and the body 10. FIG. 7a-7c, depict different possible configurations of the cutouts configured on the leaf spring 20a, 20b. In accordance with an embodiment the cutout is in form of a fillet at the interface between the leaf spring 20a, 20b and the body 10. In accordance with another embodiment of the present invention as illustrated in FIG. 7d and FIG. 7e, apart from cutouts formed on the leaf spring 20a, 20b at the interface between the leaf spring 20a, 20b and the body 10, cutouts are also formed at the portion of the body 10 opposite to the cutouts formed on the leaf spring 20a, 20b. In one embodiment, as illustrated in FIG. 7d, the cutouts formed on the leaf spring 20a, 20b and cutouts formed on the portion of the body 10 opposite to the cutouts formed on the leaf spring 20a, 20b are symmetrical to each other. The spring element 100 of the present invention further includes strategically disposed straight sections that extends from the plane of the body 10 along a straight line to prevent high displacement at critical sections of the spring element due to displacement traversing to the critical sections thereof.

Although the spring element 100 explained in the forthcoming description and depicted in the accompanying drawings includes one connecting section 14, depending upon the number of mounting sections, the number of the connecting sections can be more than one as well. More specifically, the present invention is not limited to any particular configuration, placement and number of the mounting sections and the connecting sections, as far as the mounting sections are capable of mounting the body 10 on the housing 310.

In accordance with an embodiment of the present invention, the connecting section 14 includes at least one opening 30a, 30b. Although the spring element 100 explained in the forthcoming description and depicted in the accompanying drawings includes two openings 30a and 30b, the body 10 of the spring element 100 can be configured with one opening or more than one opening. The openings 30a and 30b are formed on the connecting section 14 and each opening 30a, 30b circumscribes or surrounds at least a portion of a periphery of the corresponding leaf spring 20a, 20b. The leaf spring 20a, 20b is comparatively smaller than the respective opening 30a, 30b. The openings 30a and 30b formed on the connecting section 12 and disposed spaced away from each other, thereby forming a central bridge 14a. More specifically, the openings 30a and 30b are disposed on either side of the central bridge 14a. The spaced apart openings 30a and 30b are coplanar with respect to each other.

In order to prevent stress concentrations at critical sections of the leaf springs 20a and 20b, the stress relieving section 28a, 28b in the form of cutout is formed along at least one lateral side of the leaf spring 20a, 20b and proximal to the first portion 22a, 22b of the at least one leaf spring 20a, 20b. More specifically as illustrated in the accompanying drawings, the cutouts 28a and 28b are provided on both lateral sides of the leaf spring 20a and 20b and proximal to the first portion 22a, 22b of the leaf spring 20a, 20b. The lateral side of the leaf spring 20a, 20b is an edge of the plane forming the leaf spring 20a, 20b. Particularly, the lateral sides define the width of the leaf spring between them. The cutouts 28a, 28b prevent stress concentration at the first portion 22a, 22b of the leaf spring 20a, 20b secured to the body 10 by providing gradual change in cross section at the interface of the connection between the leaf spring 20a, 20b and the body 10. Generally, the cutout 28a, 28b provided at the first portion 22a, 22b of the leaf spring 20a, 20b proximal to the fixed end of the leaf spring 20a, 20b is C-shaped. The radius of the C-shaped cutout 28a, 28b is in the range of 1 to 5 mm. However, the present invention is not limited to any particular configuration of the cutout as far as the cutout causes gradually change in the cross section at the interface between the first portion 22a, 22b of the leaf spring 20a, 20b and the body 10 of the spring element 100. The cutout 28a, 28b prevents stress concentration at the first portion 22a, 22b of the respective leaf spring 20a, 20b.

Further, the part 26a, 26b of the first portion 22a, 22b of the corresponding leaf spring 20a, 20b is a straight section. More specifically, the first portion 22a, 22b of the leaf spring 20a, 20b includes a connecting part and the remaining part 26a, 26b. The connecting part of the first portion 22a, 22b of the leaf spring 20a, 20b is secured to the body 10 and protrudes from the plane of the body 10. The remaining part 26a, 26b of the first portion 22a, 22b angularly extends with respect to the plane of the body 10 along a straight line as depicted in FIG. 5. More specifically, the leaf spring 20a, 20b protrudes angularly from the plane of the body 10 and in a direction opposite to the mounting section 12a, 12b of the body 10 in an inclined manner. Such straight configuration of the part 26a, 26b of the first portion 22a, 22b of the leaf spring 20a, 20b provide stiffness to the first portion 22a, 22b of the respective leaf spring 20a, 20b. More specifically, the straight section prevents displacement from traversing to the interface between the first portion 22a, 22b of the respective leaf spring 20a, 20b and the body 10. Alternatively, the part 26a, 26b of the first portion 22a, 22b of the respective leaf spring 20a, 20b includes ribs 29a, 29b formed thereon to enhance the stiffness to the first portion 22a, 22b of the respective leaf spring 20a, 20b. By increasing the stiffness of the first portion 22a,22b, displacement from section of the leaf spring 20a, 20b urging the IGBT against the housing 310 is prevented from traversing to the interface between the first portion 22a, 22b of the respective leaf spring 20a, 20b and the body 10. However, the present invention is not limited to configuring at least a part of the first portion as straight section or providing ribs on at least a part of the first portion of the leaf spring to enhance stiffness thereof. Any other modification can be made to the part of the first portion of the leaf spring to enhance stiffness of the first portion.

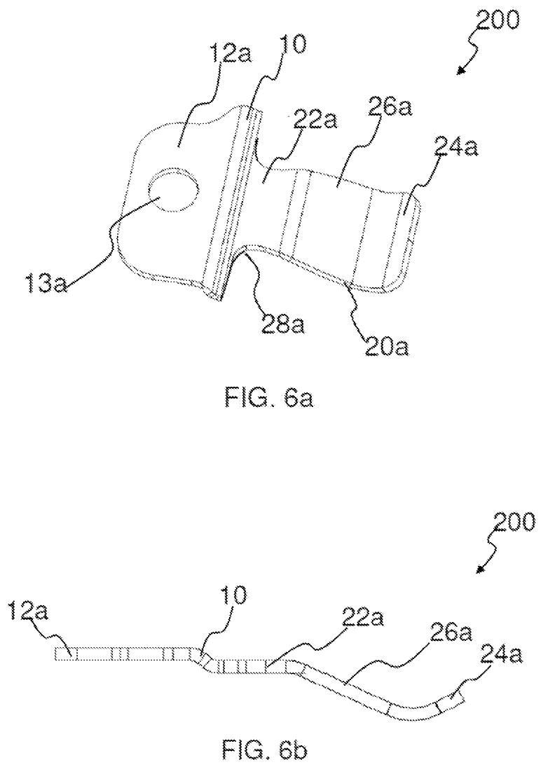

Instead of the spring element 100 including the body 10 formed with a pair of mounting sections 12a and 12b connected by the connecting section 14, two openings 30a, 30b formed on the connecting section 14, pair of leaf springs 20a and 20b, with at least a portion of the periphery of each leaf spring 20a, 20b surrounded by the respective opening 30a, 30b, the spring element could include single mounting section 12a and leaf spring 20a connected to each other as illustrated in FIG. 6a and FIG. 6b. More specifically, FIG. 6a illustrates an isometric view of a spring element 200 in accordance with another embodiment of the present invention, wherein the spring element 200 includes only one mounting section 12a and only one leaf spring 20a, and accordingly, the spring element 200 illustrated in FIG. 6a is without the connecting section 14. FIG. 6b illustrates a side view of the spring element 200. The spring element 200 is mounted on the housing 310 of the electric heater 300 through bolts. Specifically, the spring element 200 either singly or in conjunction with another similar spring element 200 exerts pressure on the IGBT holder 500, the thermal pad 600 and the IGBT 400 that are sequentially arranged in this order with respect to each other and the housing 310. More specifically, the spring element 200 exerts urging pressure on the IGBT 400 to urge the IGBT 400 against the housing 310, when the body 10 is mounted on the housing 310 by tightening the bolts. The elements of the spring element 200, e.g. the mounting section and the leaf spring, are functionally and structurally similar to the mounting section and the leaf spring of the spring element 100 and hence are not described in details for the sake of brevity of the present document.

Further there is disclosed an electrical heater 300 in accordance with an embodiment of the present invention. The electrical heater 300 includes at least one Insulated Gate Bipolar Transistor (IGBT) 400 urged against a housing 310 of the electrical heater 300 by the spring element 100 as disclosed above.

What is claimed is:

1. A spring element comprising:
a body comprising including a first mounting section to mount the body on a housing; and
a first leaf spring including
a first portion and a second portion, the first portion being secured to the body and, with at least a part thereof extending angularly with respect to a plane of the body, the first leaf spring being adapted to exert a predetermined urging pressure on an element disposed between the body and the housing as the body is mounted on the housing; and a stress relieving section formed along at least one lateral side of the first leaf spring and proximal to the first portion.

2. The spring element as claimed in claim 1, wherein the body comprises includes a second mounting section and at least one connecting section disposed between and connecting the first mounting section and the second mounting section to define the plane of the body.

3. The spring element as claimed in claim 2, wherein the first mounting section and the second mounting section are coplanar with respect to each other and offset from the plane of the body.

4. The spring element as claimed in claim 1, wherein the first mounting section includes a mounting hole formed thereon to receive a mounting bolt for mounting the body on the housing.

5. The spring element as claimed in claim 4, wherein a center of the mounting hole is aligned to a longitudinal axis of the first leaf spring and is proximal to the first portion of the first leaf spring.

6. The spring element as claimed in claim 2, further comprising a second leaf spring, wherein the at least one connecting section includes a pair of spaced apart openings configured thereon and defining a central bridge portion between the openings, with one opening of the pair of spaced apart openings circumscribing at least a portion of a periphery of the first leaf spring and another opening of the pair of spaced apart openings circumscribing at least a portion of a periphery of the second leaf spring.

7. The spring element as claimed in claim 6, wherein the openings of the pair of spaced apart openings are coplanar with respect to each other.

8. The spring element as claimed in claim 1, wherein the first leaf spring is of varying width along length thereof, the length of the first leaf spring being determined along a longitudinal axis along which the first leaf spring extends from the body, with the width of the first leaf spring being determined along a direction orthogonal to the longitudinal axis of the at least one leaf spring.

9. The spring element as claimed in claim 6, wherein the first leaf spring is comparatively smaller than the respective opening of the pair of spaced apart openings.

10. The spring element as claimed in claim 2, wherein at least a portion of the first leaf spring protrudes from the plane of the body away from the first mounting section of the body.

11. The spring element as claimed in claim 1, wherein a connecting part of the first portion of the first leaf spring secured to the body protrudes from the plane of the body and the remaining part of the first portion angularly extends with respect to the plane of the body along a straight line.

12. The spring element as claimed in claim 1, wherein the stress relieving section is in a form of a cutout.

13. The spring element as claimed in claim 12, wherein the cutout is a C-shaped cutout formed on both lateral sides of the first leaf spring and proximal to the first portion of the first at least one leaf spring.

14. The spring element as claimed in claim 13, wherein radius of the C-shaped cutout is in the range of 1 to 5 mm.

15. An electrical heater comprising:
a housing,
a spring element including:
a body including a first mounting section to mount the body on a housing; and
a first leaf spring including
a first portion and a second portion, the first portion being secured to the body, with at least a part thereof extending angularly with respect to a plane of the body, the first leaf spring being adapted to exert a predetermined urging pressure on an element disposed between the body and the housing as the body is mounted on the housing; and a stress relieving section formed along at least one lateral side of the first leaf spring and proximal to the first portion; and
at least one power transistor urged against the housing by the spring element.
